(19) United States
(12) Patent Application Publication
(10) Pub. No.: US 2004/0263051 A1
(43) Pub. Date: Dec. 30, 2004

(54) Cathode ray tube

(76) Inventors: Gyung Rae Kim, Gumi-si (KR); Yong Hoon Choi, Daegu-si (KR)

Correspondence Address: BIRCH STEWART KOLASCH & BIRCH, PO BOX 747, FALLS CHURCH, VA, 22040-0747, US

(21) Appl. No.: 10/703,558

(22) Filed: Nov. 10, 2003

(30) Foreign Application Priority Data
Jun. 24, 2003 (KR) 41031/2003

(51) Int. Cl. H01J 31/00; H04N 5/65

(52) U.S. Cl. 313/477 R; 348/822; 348/823; 348/824; 313/479

(57) ABSTRACT

A cathode ray tube comprises a panel of which outer surface is substantially flat and inner surface has a designated radius of curvature, a shadow mask coupled to the panel, the shadow mask having electron beam passing holes, and a reinforcing band mounted on the outer surface of the panel, wherein a diagonal size of an effective surface of the panel is in the range of 397-463 mm, and a thickness of a diagonal end of the effective surface of the panel is in the range of 20-23 mm.

### BACKGROUND OF THE INVENTION

1. Field of the Invention

The present invention relates in general to a cathode ray tube, more particularly, to a cathode ray tube with an improved panel structure, whereby damages from a heat treatment process can be minimized and total weight and expense of manufacture of the panel can be reduced.

2. Discussion of the Background Art

FIG. 1 illustrates the structure of a related art cathode ray tube.

Referring to FIG. 1, the cathode ray tube includes a panel 1 having a fluorescent screen 4 formed on an inner surface thereof, a funnel 1 connected to the panel 2, a shadow mask 3 with a color selecting function, being disposed at a designated distance from the fluorescent screen 4, a mask frame 5 for supporting the shadow mask 3, an electron gun 8 housed in a neck portion 10 of the funnel 2 for emitting electron beams 11, and a deflection yoke 9 for deflecting the electron beams 11.

Particularly, the mask frame 5 is coupled to the panel 1 by means of the mask spring 6, and an inner shield 7 shields the influence of a geomagnetic field on the operation of the cathode ray tube.

Given that the panel 1 and the funnel 2 are being welded to each other, inside of the cathode ray tube remains in vacuum state by an exhaust process. Because of the difference from outer atmospheric pressure, however, the cathode ray tube is subject to a certain amount of stress acting thereon.

Especially, excessive compressive stress is sometimes applied to a central portion of the panel 1. In such case, the cathode ray tube can be easily damaged by external impacts, and sometimes imploded. Therefore, to lessen stress acting upon the cathode ray tube, as shown in FIG. 2, a reinforcing band 12 is mounted on an outer peripheral portion of the panel 1.

When a designated voltage is applied to the cathode ray tube, the electron gun 8 emits electron beams 11, and the electron beams 11 are deflected by the deflection yoke 9, and collided with the fluorescent screen 4, eventually displaying an image on the screen.

FIG. 3 depicts a panel of which inner surface and outer surface have a designated radius of curvature, respectively, and FIG. 4 depicts a panel of which outer surface is substantially flat while inner surface has a radius of curvature.

As shown in FIGS. 3 and 4, the related panel 1 is largely divided into two types: one is a panel 1a of which inner and outer surfaces have designated radii of curvature, and the other is a panel 1b of which outer surface is substantially flat while inner surface has a designated radius of curvature.

Particularly, the panel 1b having a flat outer surface and curved inner surface, compared to the other, has less image distortions.

In recent years, as cathode ray tubes are getting bigger, the size of the panel 1 and shadow mask 3 are also getting bigger.

Therefore, to maintain the strength of the panel 1, not only the thickness of the panel has been increased, but also the weight of the panel 1 and shadow mask 3 have been increased, consequently increasing manufacturing cost

Referring to FIG. 5, unlike the panel 1a of which outer and inner surfaces have a designated radius of curvature, respectively, the panel 1b of which outer surface is substantially flat and inner surface has a designated radius of curvature has a greater distance (OMH) from a seal edge line to a mold match line, and is relatively thicker and heavier, so its manufacturing cost is also higher.

In addition, when the panel 1 gets thicker, inside of a furnace is often damaged due to the difference of thermal conductivity, and brightness is degraded as well.

As one attempt to compensate brightness degradation, some manufacturers tried to increase the width of fluorescent substance. However, this only brings another problem. That is, to increase the width of fluorescent substance, the width of a (dichroic) black matrix distinguishing fluorescent substances should be reduced, but in such case, color purity is degraded.

Therefore, there is a need to develop a method for reducing the thickness of the panel 1 while maintaining the strength thereof.

### SUMMARY OF THE INVENTION

An object of the invention is to solve at least the above problems and/or disadvantages and to provide at least the advantages described hereinafter.

Accordingly, one object of the present invention is to solve the foregoing problems by providing a cathode ray tube with an improved panel structure, whereby damages from a heat treatment process can be minimized and total weight and expense of manufacture can be reduced.

Another object of the present invention is to provide a cathode ray tube with less weight and lower expense of manufacture, despite of large-sized cathode ray tubes, and large panels and shadow masks therein.

Another object of the invention is to provide a cathode ray tube with an excellent explosion-proof characteristic against an increased stress due to a reduced thickness of a panel.

The foregoing and other objects and advantages are realized by providing a cathode ray tube, including a panel of which outer surface is substantially flat and inner surface has a designated radius of curvature; a shadow mask coupled to the panel, the shadow mask having electron beam passing holes; and a reinforcing band mounted on the outer surface of the panel, wherein a diagonal size of an effective surface of the panel is in the range of 397-463 mm, and a thickness at a central portion of the panel is in the range of 9.5-11.5 mm.

Another aspect of the invention provides a cathode ray tube, including: a panel of which outer surface is substantially flat and inner surface has a designated radius of curvature; a shadow mask coupled to the panel, the shadow mask having electron beam passing holes; and a reinforcing band mounted on the outer surface of the panel, wherein a diagonal size of an effective surface of the panel is in the range of 397-463 mm, and a thickness of a diagonal end of the effective surface of the panel is in the range of 20-23 mm.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates the structure of a related art cathode ray tube;

FIG. 2 illustrates a related art reinforcing band;

FIG. 3 illustrates a panel of which inner and outer surfaces have a designated radius of curvature, respectively;

FIG. 4 illustrates a panel of which outer surface is substantially flat and inner surface has a designated radius of curvature;

FIG. 5 diagrammatically compares a panel of which inner and outer surfaces have a designated radius of curvature, respectively, to a panel of which outer surface is substantially flat and inner surface has a designated radius of curvature;

FIG. 6 depicts a panel in a cathode ray tube according to the present invention;

FIG. 7 is a cross-sectional view of a panel in a cathode ray tube according to the present invention; and

FIG. 8 illustrates a reinforcing band for a cathode ray tube according to the present invention.

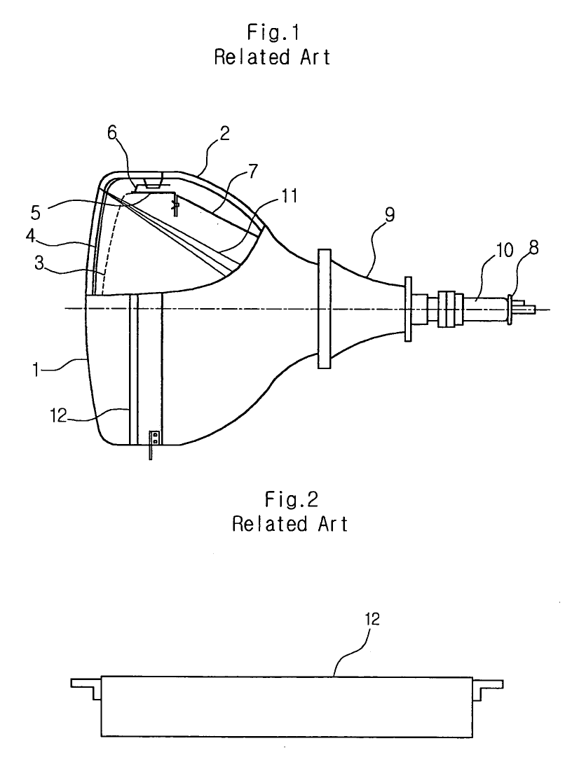

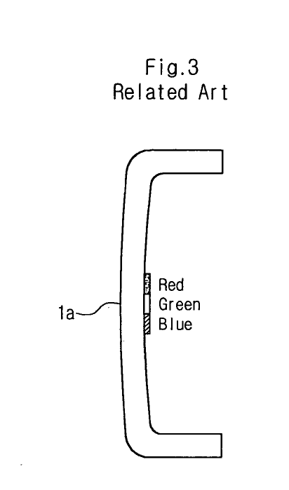

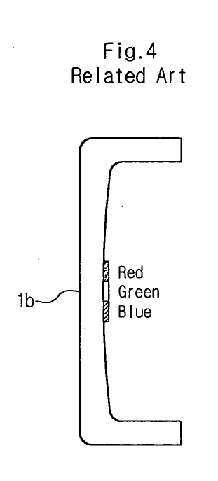

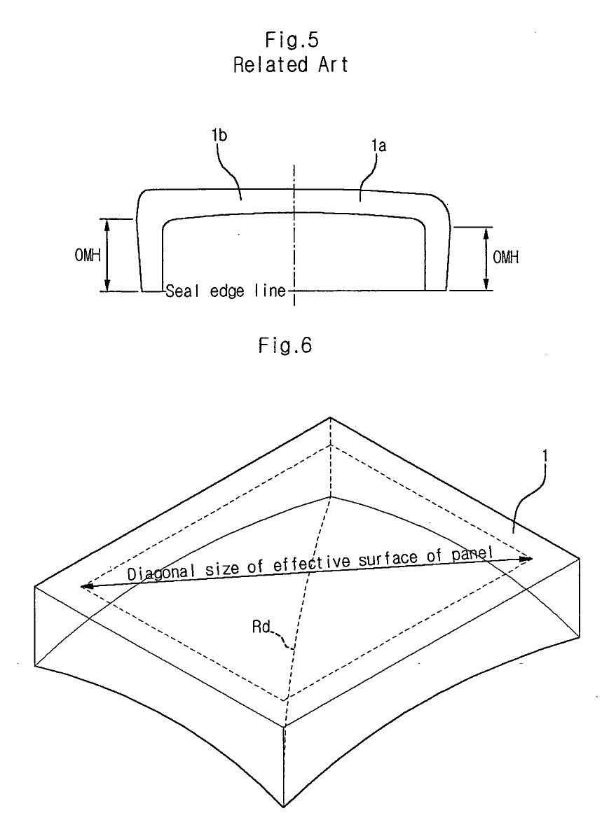

### DETAILED DESCRIPTION OF PREFERRED EMBODIMENTS

The following detailed description will present a cathode ray tube according to a preferred embodiment of the invention in reference to the accompanying drawings.

The cathode ray tube of the invention includes: a panel having a skirt portion standing on a peripheral portion of the panel and being almost vertically extended to an inner and outer surfaces of the panel, in which the outer surface is substantially flat and the inner surface has a designated radius of curvature; a funnel connected to the panel, a fluorescent screen formed on the inner surface of the panel; an electron gun for emitting electron beams; a deflection yoke for deflecting the electron beams; a shadow mask with a color selection function of the electron beams; and a reinforcing band mounted on the skirt portion of the panel, to reduce stress from atmospheric atmosphere.

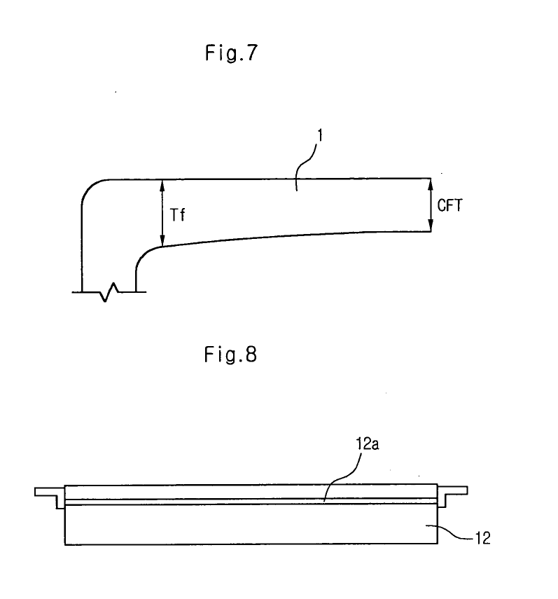

FIG. 6 depicts a panel in a cathode ray tube according to the present invention, and FIG. 7 is a cross-sectional view of a panel in a cathode ray tube according to the present invention.

In FIGS. 6 and 7, ‘CFT’ denotes a thickness at a central portion of the panel 1, and ‘Tf’ denotes a thickness of a diagonal end portion of an effective surface of the panel 1.

Also, ‘Rd’ denotes a radius of curvature of the inner surface of the panel 1. Although not shown in the drawings, ‘Rz’ denotes a value obtained dividing the radius of curvature of the inner surface (Rd) of the panel 1 by a representative value (diagonal size of the effective surface*1.767) (i.e. Rz=Rd/(diagonal size of the effective surface*1.767)).

As the panel 1 is getting bigger and lighter, there is a need to reduce the thickness of the panel 1. The panel 1, therefore, should be carefully designed in consideration of all the factors, CFT, Tf and Rz.

Meanwhile, when electron beams emitted from the electron gun strike the fluorescent screen or the shadow mask, a small amount of X-ray is usually produced, and the X-ray is emitted through the panel 1. Although the amount of X-ray being produced is so small that it is insignificant, its upper limit has been set for the safety of users.

Preferably, the diagonal size of the effective surface of the panel 1 ranges from 397 to 463 mm, and the thickness at the central portion (CFT) of the panel 1 ranges from 9.5 to 11.5 mm.

If the thickness at the central portion (CFT) of the panel 1 is less than 9.5 mm, the panel could be affected by X-ray, meaning it is no longer safe from X-ray, and the strength of the panel 1 is also lessened. On the other hand, if the thickness at the central portion (CFT) of the panel 1 is greater than 11.5 mm, the weight of the panel 1 is increased because of the increased thickness of the panel 1, and thus, an optimal brightness cannot be obtained.

More preferably, the thickness at the central portion (CFI) of the panel 1 ranges from 10 to 11 mm.

In addition, as for the cathode ray tube of the invention, the thickness of the diagonal end portion (Tf) of the panel 1 should be in the range of 20-23 mm. If the thickness of the diagonal end portion of) of the panel 1 is less than 20 mm, the explosion-proof characteristic is deteriorated due to stress action thereon. But if the thickness of the diagonal end portion of) of the panel 1 is greater than 23 mm, this results different thermal conductivities and thus, the panel can be easily damaged in a furnace.

Besides, a wedge rate (Pw) of the panel 1 is preferably in the range of 190-220%. With the wedge rates (Pw) in the above ranges, one can improve brightness uniformity on an image screen.

A transmittance at the central portion (Tco) of the panel 1 using the clear glass is preferably in the range of 77-82%, and a transmittance at the central portion (Tco) of the panel 1 using the tint glass is preferably in the range of 54-58%. With the transmittance rates at the central portion (Tco) in the above ranges, one can prevent degradations in brightness and improve contrast quality.

Moreover, a transmittance at the diagonal end portion (Tce) of the panel 1 using the clear glass is preferably in the range of 71-77%, and a transmittance at the diagonal end portion (Tce) of the panel 1 using the tint glass is preferably in the range of 31.5-35.5%. With the transmittance rates at the diagonal end portion (Tce) in the above ranges, one can secure brightness uniformity on the image screen, without reducing black matrix on the peripheral portion of the panel 1.

As the structure of the panel 1 is improved, the thickness of the shadow mask is also changed to be in the range of 0.1-0.13 mm. As for material of the shadow mask, Fe—Ni alloy or Fe—Ni—Co alloy is desired. In this manner, the strength of the shadow mask is improved, and the weight and expense of manufacture of the cathode ray tube is reduced.

Further, in consideration of an explosion-proof characteristic of the panel 1, and the reduced weight and expense of manufacture of the cathode ray tube, manufacturers employ a reinforcing band 12 having embossment 12a in a longitudinal direction on the surface of the reinforcing band 12 facing a mold match line. As FIG. 8 illustrates, the main purpose of this embossment 12a formed in the longitudinal direction is to improve clamping force of the reinforcing band 12.

Here, a thickness (Tb) of the reinforcing band is preferably in the range of 0.8-1.2 mm. If the thickness Crb) of the reinforcing band is less than 0.8 mm, the clamping force of the reinforcing band 12 is lessened so that it cannot compensate external stress as it is supposed to. On the other hand, if the thickness (Tb) of the reinforcing band is greater than 1.2 mm, the weight and expense of manufacture of the cathode ray tube will be increased.

In conclusion, the cathode ray tube of the invention can be advantageously used in that it minimizes damages from a heat treatment process and reduces total weight and expense of manufacture.

Another advantage of the cathode ray tube of the invention is that it has less weight and lower expense of manufacture, despite of large-sized cathode ray tubes, and large panels and shadow masks therein.

Lastly, the cathode ray tube of the invention has an excellent explosion-proof characteristic against an increased stress due to the reduced thickness of the panel.

While the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A cathode ray tube, comprising:
a panel of which outer surface is substantially flat and inner surface has a designated radius of curvature;
a shadow mask coupled to the panel, the shadow mask having electron beam passing holes; and
a band mounted on the outer surface of the panel, wherein a diagonal size of an effective surface of the panel is in the range of 397-463 mm, and a thickness of a diagonal end of the effective surface of the panel is in the range of 20-23 mm.

2. The cathode ray tube according to claim 1, wherein the thickness of a central portion of the panel is in the range of 9.5-11.5 mm.

3. The cathode ray tube according to claim 1, wherein a wedge rate of the panel is in the range of 190-220%.

4. The cathode ray tube according to claim 1, wherein a thickness of the shadow mask is in the range of 0.1-0.13 mm.

5. The cathode ray tube according to claim 4, wherein material of the shadow mask is Fe—Ni alloy or Fe—Ni—Co alloy.

6. The cathode ray tube according to claim 1, wherein a transmittance at the central portion of the panel is in the range of 77-82%.

7. The cathode ray tube according to claim 1, wherein a transmittance at the central portion of the panel is in the range of 54-58%.

8. The cathode ray tube according to claim 1, wherein a transmittance at a diagonal end of the effective surface of the panel is in the range of 71-75%.

9. The cathode ray tube according to claim 1, wherein a transmittance at a diagonal end of the effective surface of the panel is in the range of 31.5-35.5%.

10. The cathode ray tube according to claim 1, wherein a thickness of the band is in the range of 0.8-1.2 mm.

11. The cathode ray tube according to claim 1, wherein embossment is set in a longitudinal direction of the band.

12. The cathode ray tube according to claim 11, wherein the embossment is formed on the surface of the band facing a mold match line.

13. The cathode ray tube according to claim 1, wherein the thickness of a central portion of the panel is in the range of 10-11 mm.

14. A cathode ray tube, comprising:
a panel of which outer surface is substantially flat and inner surface has a designated radius of curvature;
a shadow mask coupled to the panel, the shadow mask having electron beam passing holes; and
a band mounted on the outer surface of the panel, wherein a diagonal size of an effective surface of the panel is in the range of 397-463 mm, and a thickness at a central portion of the panel is in the range of 9.5-11.5 mm.

15. The cathode ray tube according to claim 14, wherein a wedge rate of the panel is in the range of 190-220%.

16. The cathode ray tube according to claim 14, wherein a thickness of the shadow mask is in the range of 0.1-0.13 mm.

17. The cathode ray tube according to claim 16, wherein material of the shadow mask is Fe—Ni alloy or Fe—Ni—Co alloy.

18. The cathode ray tube according to claim 14, wherein a transmittance at the central portion of the panel is in the range of 77-82%.

19. The cathode ray tube according to claim 14, wherein a transmittance at the central portion of the panel is in the range of 54-58%.

20. The cathode ray tube according to claim 14, wherein a transmittance at a diagonal end of the effective surface of the panel is in the range of 71-75%.

21. The cathode ray tube according to claim 14, wherein a transmittance at a diagonal end of the effective surface of the panel is in the range of 31.5-35.5%.

22. The cathode ray tube according to claim 14, wherein a thickness of the band is in the range of 0.8-1.2 mm.

23. The cathode ray tube according to claim 14, wherein embossment is set in a longitudinal direction of the band.

24. The cathode ray tube according to claim 23, wherein the embossment is formed on the surface of the band facing a mold match line.

25. The cathode ray tube according to claim 14, wherein the thickness of a central portion of the panel is in the range of 10-11 mm.
